(19) United States
(12) Patent Application Publication
(10) Pub. No.: US 2024/0132661 A1
(43) Pub. Date: Apr. 25, 2024

(54) COMPOSITION AND PROCESS FOR PRODUCING A TRANSLUCENT THERMOPLASTIC POLYCARBONATE-POLYMETHYL METHACRYLATE MOLDING COMPOUND

(71) Applicant: Covestro Deutschland AG, Leverkusen (DE)

(72) Inventors: Andreas Seidel, Dormagen (DE); Mandy Gieler, Dernau (DE); Tobias Bubmann, Bayreuth (DE); Volker Altstädt, Hamburg (DE)

(21) Appl. No.: 18/265,778

(22) PCT Filed: Dec. 13, 2021
(86) PCT No.: PCT/EP2021/085352

§ 371 Date: Jun. 7, 2023

(30) Foreign Application Priority Data
Dec. 18, 2020 (EP) 20215265.8

(51) Int. Cl. C08G 64/06; B29C 48/00; C08F 220/14; C08F 220/32; C08K 5/098; B29K 33/00; B29K 69/00

(52) U.S. Cl. CPC C08G 64/06; B29C 48/022; C08F 220/14; C08F 220/325; C08K 5/098; B29K 2033/12; B29K 2069/00

(57) ABSTRACT

The present invention relates to a composition for producing a thermoplastic molding compound containing
A) at least one aromatic polycarbonate and/or aromatic polyester carbonate containing at least 500 ppmw of phenolic OH groups, wherein the weight-average molecular weight M_{w} of component A determined by gel permeation chromatography at room temperature in dichloromethane as solvent using a polycarbonate calibration standard is in the range from 15 000 to 40 000 g/mol,
B) at least one copolymer containing structural units derived from methyl methacrylate and 0.3% to 15% by weight, based on component B, of structural units derived from glycidyl methacrylate, wherein component B has a weight-average molecular weight M_{w} determined by gel permeation chromatography at room temperature in tetrahydrofuran as solvent using a polystyrene standard of 20 000 to 200 000 g/mol,
wherein in component B the ratio of M_{w} in kg/mol to the weight fraction of glycidyl methacrylate-derived structural units in % by weight is in the range from 2 to 100,
wherein the weight ratio of component A and component B is in the range from 30:70 to 90:10,
   and to a process for producing a molding compound from the composition, to a molding compound obtainable by the process, to the use of the molding compound for producing molded articles, to the molded articles themselves and to a process for producing the molded articles.

The present invention relates to a polycarbonate/polymethylmethacrylate composition for producing a thermoplastic polycarbonate/polymethyl methacrylate molding compound, to a process for producing the molding compound, to the molding compound itself, to the use of the molding compound for producing molded articles, to the molding articles containing such a molding compound and to a process for producing molded articles.

Driven not least by the development of LED light source technology and the resulting novel concepts for illumination and function integration, transparent and translucent thermoplastic molding compounds suitable for producing molded articles transilluminable by visible light have become increasingly important in recent years in many fields of application, for example in the automotive sector, in the building sector and in the electronics sector.

The profile of properties of traditional transparent thermoplastic polymer materials such as polycarbonate (PC) and polymethyl methacrylate (PMMA) is increasingly reaching its limits in the case of many of these novel applications. For example, in the case of transilluminable components in automobile interiors, for example instrument panel carriers or decorative trim pieces, or in automotive body applications intended to serve for example for ambient lighting or appropriately switchable functional display functions, there is often a need for a material ductility that is improved over PMMA and for a scratch resistance or suncream resistance that is improved over PC. It is accordingly obvious for a person skilled in the art to make use of polymer blend technology to combine with one another the individual advantages of these two materials (high scratch resistance and good suncream resistance of PMMA on the one hand and ductility of PC on the other hand).

The properties of such PC/PMMA molding compounds and the molded articles produced therefrom may be varied over wide ranges and adapted to the requirements of the respective application through suitable choice of their composition and production conditions. This makes it possible to produce molding compounds having a very wide variety of property profiles which are essentially often between those of pure PC and those of pure PMMA.

However, this does not in principle applied to transparency. Since PC and PMMA melts are not completely miscible, the compounding of PC/PMMA blends generally results in biphasic morphologies in which the polymer used in excess forms the matrix phase in which the respective other polymer is relatively friendly divided and thus exhibits a multiplicity of microscopic phase interfaces. Incident light is scattered at these PC-PMMA phase interfaces due to the different refractive indices of the two polymers.

The result is a high opacity (i.e. very low light transmittance) of the PC/PMMA blends compared to the two polymeric blend partners.

The phase interfaces may also be weak points in respect of mechanical stresses. These phase interfaces may for example result in failure with respect to external stresses on the molded article, in particular when the molded article is in contact with certain media such as fats or oils which are constituents of foodstuffs, lubricants or cosmetic products (for example handcream or suncream).

A previously unresolved objective in material development was accordingly that of providing PC/PMMA blends which are suitable for producing transparent or translucent (i.e. transilluminable) molded articles via a thermoplastic forming process and which in each case exhibit an advantageous combination of properties relative to polycarbonate and polymethyl methacrylate. This would solve a multiplicity of technical problems.

Various scientific publications and patent documents of the last 10 years have disclosed that transparent PC/PMMA blends having improved technical properties are producible through the use of block copolymers which may often be formed in situ in a reactive extrusion.

WO 2020/212229 A1 discloses a reactive compounding process for producing a thermoplastic molding compound using aromatic polycarbonate and a further polymer which contains at least one type of functional groups selected from ester, epoxy, hydroxy, carboxyl and carboxylic anhydride groups, wherein the catalyst employed is a special phosphonium salt. The application especially also discloses the production of transparent thermoplastic PC/PMMA molding compounds in such a process.

WO 2016/138246 A1 discloses transparent PC/PMMA blends containing 9.9-40% by weight of polycarbonate and 59.9-90% by weight of PMMA which are produced in a melt extrusion using 0.0025-0.1% by weight of a tin catalyst.

WO 2016/189494 A1 discloses transparent PC/PMMA blends containing 80-95% by weight of a specifically specified branched polycarbonate having an end cap content of 45%-80% and 4.9-20% by weight of PMMA which are produced in a melt extrusion by transesterification using 0.1-1.5% by weight of a catalyst, preferably selected from Zn, Sn and Ag compounds.

A. K. Singh, et al. “Reactive Compatibilization of Polycarbonate and Poly(methyl)methacrylate in the Presence of a Novel Transesterification Catalyst SnCl₂·2H₂O”, J. Phys. Chem. B 2011, 115, 1601-1607 discloses transparent PC/PMMA molding compounds produced in a reactive compounding process using SnCl₂·2H₂O as catalyst.

A. K. Singh, et al. “Evidence for in situ graft copolymer formation and compatibilization of PC and PMMA during reactive extrusion processing in the presence of the novel organometallic transesterification catalyst tin (II) 2-ethylhexanoate”, RSC Advances, 2012, 2, 10316-10323 discloses translucent PC/PMMA molding compounds produced in a reactive extrusion process using tin(II) 2-ethylhexanoate as catalyst.

T. Bubmann et al. “Transparent PC/PMMA Blends Via Reactive Compatibilization in a Twin-Screw Extruder” Polymers 2019, 11, 2070 discloses that, as a result of an interpolymeric transesterification reaction and thus formation of PC-g-PMMA graft polymers during the reactive extrusion, such PC+PMMA molding compounds produced in reactive extrusion processes according to previously cited prior are indeed transparent but exhibit insufficient material ductility for any industrial application. Proposed as a reason therefor is the molecular weight reduction of the polycarbonate accompanying the transesterification which also contributes decisively to the transparency in the blends thus produced since the miscibility of PC and PMMA improves with decreasing PC molecular weight, thus resulting in monophasic phase morphologies in the blends produced by reactive extrusion.

U.S. Pat. No. 8,975,346 B2 discloses a process for producing a block copolymer where an aromatic PC having terminal OH groups and having a weight-average molecular weight of at least 3400 g/mol is esterified with an acid halide to form a macroinitiator and this polycarbonate macroinitiator thus produced is reacted with a vinyl monomer, in particular methyl methacrylate, in a controlled free-radical atom-transfer polymerization reaction. The PC-b-PMMA block copolymers produced in this way are notable for their transparency and good scratch resistance.

E. A. Kan, et al. “The effects of PC-PMMA block copolymer on the compatibility and interfacial properties of PC/SAN blends”, Polymer Engineering and Science, 2000, 40 (11), 2374-2384 discloses PC-b-PMMA and PC-b-SAN block copolymers produced by free-radical polymerization of methyl methacrylate or a styrene-acrylonitrile mixture in the presence of a vinyl-terminated PC in chloroform as solvent.

H. Jang, et al. “Polycarbonate-co-PMMA block copolymers via atom transfer radical polymerization reaction” J. Nanosci. Nanotechnol., 2017, 17 (10), 7281-7386 discloses PC-b-PMMA block copolymers produced by radical polymerization of methyl methacrylate in the presence of an allyl-terminated PC in tetrahydrofuran as solvent. The block copolymers have a scratch resistance that is better than PC.

The processes disclosed in the latter three prior art documents which are based on the grafting of PMMA onto especially reactively modified polycarbonate macromonomers in (controlled) free-radical polymerization processes are technologically complex, have low efficiency and are costly and difficult to reproduce on an industrial scale.

It was accordingly desirable to provide a composition for producing a thermoplastic PC/PMMA molding compound, wherein production of the molding compound is possible with a commercially available and industrially established compounding apparatus such as for example a single-screw extruder, a co-rotating or counter-rotating twin-screw extruder, a planetary roller extruder, an internal kneader or a co-kneader and wherein the molding compound makes it possible to produce transilluminable (translucent or transparent) molded articles having at least one mechanical property which is improved relative to such PC/PMMA molded articles of the prior art. Mechanical properties sought to be improved in the context of the present invention include in particular tensile strength, flexural strength, flexural elongation at break, scratch resistance and chemicals resistance.

In the context of the present invention a transilluminable molded article is to be understood as meaning a molded article which at least one location has a local total luminous transmittance measured according to ISO 13468-1 (2019 version) of at least 35%, preferably at least 50%.

It was moreover desirable to provide compositions for producing PC/PMMA molding compounds suitable for producing transilluminable molded articles having a flexural strength that is improved over both pure PC and pure PMMA. It is especially sought to achieve a flexural strength measured according to ISO 178 (2019 version) of at least 100 MPa.

The molded articles produced shall preferably have a scratch resistance that is improved compared to pure polycarbonate and/or a resistance to fats and oils and/or compositions containing fats and oils such as for example cosmetics, handcreams and suncream that is improved compared to pure polycarbonate and/or PC/PMMA compositions of the prior art. It is especially sought to achieve a scratch resistance measured as pencil hardness based on the Wolff-Wilborn method of at least 2H. It is further sought to achieve an improvement in resistance to suncream compared to pure polycarbonate.

It was particularly desirable to provide compositions for producing PC/PMMA molding compounds suitable for producing transilluminable molded articles having a flexural strength measured according to ISO 178 (2019 version) of at least 100 Mpa, a scratch resistance measured as pencil hardness based on the Wolff-Wilborn method of at least 2H, preferably at least 3H, and an improved resistance to suncream compared to pure polycarbonate, wherein a molded article having a thickness of 1 mm produced from such a molding compound has a total luminous transmittance measured according to ISO 13468-1 (2019 version) of at least 35%, preferably at least 50%.

It has now been found that, surprisingly, the desired properties are exhibited by a composition for producing a thermoplastic molding compound containing
A) at least one aromatic polycarbonate and/or aromatic polyester carbonate containing at least 500 ppmw, preferably at least 1000 ppmw, particularly preferably at least 1500 ppmw, most preferably at least 1800 ppmw, of phenolic OH groups, wherein the weight-average molecular weight M_{w} of component A determined by gel permeation chromatography at room temperature in dichloromethane as solvent using a BPA polycarbonate calibration standard is in the range from 15 000 to 40 000 g/mol, preferably from 18 000 to 35 000 g/mol, particularly preferably from 19 000 to 30 000 g/mol, most preferably from 20 000 to 28 000 g/mol,
B) at least one copolymer containing structural units derived from methyl methacrylate and 0.3% to 15% by weight, preferably 0.5% to 10% by weight, particularly preferably 0.8% to 9% by weight, most preferably 1% to 8% by weight -%, based on component B, of structural units derived from glycidyl methacrylate (GMA), wherein component B has a weight-average molecular weight M_{w} determined by gel permeation chromatography at room temperature in tetrahydrofuran as solvent using a polystyrene standard of 20 000 to 200 000 g/mol, preferably of 30 000 to 150 000 g/mol, particularly preferably of 30 000 to 100 000 g/mol, most preferably from 50 000 to 80 000 g/mol,
   wherein in component B the ratio of M_{w} in kg/mol to the weight fraction of glycidyl methacrylate-derived structural units in % by weight is in the range from 2 to 100, preferably in the range from 5 to 80, particularly preferably in the range from 5 to 50, most preferably in the range from 8 to 30.
wherein the weight ratio of components A and B is in the range from 30:70 to 90:10, preferably in the range from 45:55 to 85:15, more preferably in the range from 60:40 to 85:15

The expression “ppmw” is to be understood as meaning a weight fraction in parts per million.

In a preferred embodiment the composition consists of
30% to 90% by weight, preferably 45% to 85% by weight, particularly preferably preferably 58% to 82% by weight, of component A,
10% to 70% by weight, preferably 14% to 54% by weight, particularly preferably 17% to 41% by weight, of component B,
0% to 20% by weight, preferably 0.01% to 5% by weight, particularly preferably 0.02% to 1% by weight, of polymer additives, process auxiliaries and/or polymers distinct from components A and B as component C, wherein the % by weight amounts of components A to C are selected such that they sum to 100% by weight.

In a further preferred embodiment the product of the phenolic OH amount in ppmw introduced into the composition via component A and the amount of glycidyl methacrylate-derived structural units in % by weight introduced into the composition via component B is greater than 300. This product is calculated as the product of the amount of phenolic OH in component A (in ppm), the weight fraction of component A in the composition, the amount of glycidyl methacrylate-derived structural units in component B (in % by weight) and the weight fraction of component B in the composition.

In the case of compositions containing a component B having a ratio of Mw in kg/mol to the weight fraction of glycidyl methacrylate-derived structural units in % by weight of >50 to 100 it is preferable to employ a metal acetonate, preferably zirconium(IV) acetylacetonate, as component C or a constituent of component C in order to achieve a higher transmittance. By contrast, the case of compositions containing a component B having a ratio of Mw in kg/mol to the weight fraction of glycidyl methacrylate-derived structural units in % by weight of ≤50 such a use of a metal acetonate is not necessary to achieve a high transmittance and in the case of compositions having a high PMMA content>40% by weight it is actually preferable for achieving a high transmittance not to employ such a metal acetonate. If metal acetonate is employed as component C or a constituent of component C it is preferably employed in the compositions in an amount of 0.01% to 0.2% by weight, particularly preferably of 0.02% to 0.15% by weight, most preferably in an amount of 0.03% to 0.1% by weight.

### Component A

Component A employed is an aromatic polycarbonate and/or an aromatic polyester carbonate. It is also possible to employ mixtures of two or more aromatic polycarbonates and/or polyester carbonates.

Aromatic polycarbonates of component A which are suitable according to the invention are known from the literature or may be produced by literature processes (for production of aromatic polycarbonates see, for example, Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610, DE-A 3 832 396).

Aromatic polycarbonates are produced for example by reaction of diphenols with carbonyl halides, preferably phosgene and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with, for example, diphenyl carbonate in the presence of a transesterification catalyst is likewise possible.

The melt polymerization process is particularly suitable for producing polycarbonates of component A according to the invention. It is thus preferable to employ aromatic polycarbonates produced in the melt polymerization process as component A. The molecular weight and the proportion of phenolic OH groups is adjusted in particular via the ratio of diphenols and diphenyl carbonate and the reaction regime (in particular temperature, residence times, vacuum and catalyst type and amount). The molar ratio of diphenyl carbonate to diphenols is preferably adjusted in the range 1.00 to 1.07, particularly preferably in the range 1.01 to 1.05, most preferably in the range 1.02 to 1.04. This ratio regulates the correlation between the molecular weight and the proportion of phenolic OH end groups, wherein the molecular weights (and thus also the proportion of phenolic OH end groups) are adjustable within this correlation via the residence times under a selected reaction regime (such as temperature, vacuum and the catalyst type and amount).

Production of polycarbonates of component A in the interfacial process is usually done with a molar excess of diphenols relative to the carbonyl chloride. The target molecular weight is adjusted via the ratio of diphenols and carbonyl halide. The content of phenolic OH groups is in this case controllable via the molar ratio of monopenolic chain terminator to diphenol. In one specific embodiment no monophenolic chain terminator is employed in the production of polycarbonates of component A in the interfacial process. This forms a polycarbonate having a proportion of phenolic OH groups at the end groups in the polycarbonate of 100%.

Diphenols for production of the aromatic polycarbonates and/or aromatic polyester carbonates are preferably those of formula (1)

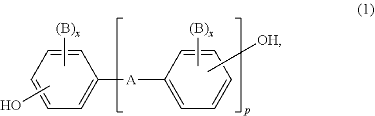

wherein
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms may be fused,
   or a radical of formula (2) or (3)

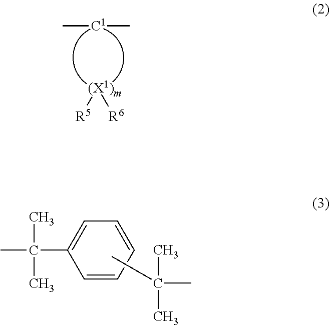

B is in each case C₁ to C₁₂-alkyl, preferably methyl, halogen, preferably chlorine and/or bromine,
x is independently at each occurrence 0, 1 or 2
p is 1 or 0, and
R⁵ and R⁶ are individually choosable for each X¹ and are independently of one another hydrogen or C₁ to C₆-alkyl, preferably hydrogen, methyl or ethyl,
X¹ is carbon and
m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also the di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is especially preferred.

The diphenols may be used individually or in the form of any desired mixtures. The diphenols are known from the literature or obtainable by literature processes.

In a preferred embodiment the proportion of bisphenol A based on the sum of all diphenols used to produce component A is at least 50 mol %, particularly preferably at least 75 mol %, most preferably at least 95 mol %. It is most preferable when exclusively bisphenol A is used as the diphenol in the production of component A.

The aromatic polycarbonates contain at least 500 ppmw, preferably at least 1000 ppmw, particularly preferably at least 1500 ppmw, most preferably at least 1800 ppmw, of phenolic OH groups. These phenolic OH groups are end groups. When linear polycarbonates are concerned, the aromatic polycarbonates of component A are generally mixtures of polycarbonate molecules having one, two and no phenolic OH groups. In the case of branched polycarbonates, polycarbonate molecules having more than two phenolic OH groups may also be present. In a preferred embodiment 25 to 100 mol %, particularly preferably 30 to 80 mol %, most preferably 40 to 75 mol %, of the end groups are in the form of phenolic OH groups in the polymer molecules of component A. The proportion of phenolic OH groups at the end groups in linear polycarbonates can be calculated using a rule of three from the number-average molecular weight of the polycarbonate Mₙ (in g/mol) and its content of phenolic OH groups (in ppmw), wherein a content of phenolic OH groups (in ppmw) of (34 g/mol)·10⁶/Mₙ corresponds to a proportion of phenolic OH groups of 100%.

The aromatic polycarbonates more preferably contain 500 ppmw to 3000 ppmw, particularly preferably 1500 ppmw to 3000 ppmw and most preferably 1800 to 2800 ppmw of phenolic OH groups.

The content of phenolic OH groups is determined by ¹H NMR spectroscopy with dichloromethane as solvent at room temperature by evaluating the ratio of the integrals of the signals at 6.68 ppm (2 aromatic protons ortho to phenolic OH groups) and at 1.68 ppm (6 methyl protons of the bisphenol A unit).

Unless otherwise explicitly stated, all ppm amounts in the present invention are to be understood as weight fractions.

Examples of chain terminators suitable for production of the aromatic polycarbonates in the interfacial process include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl)phenol according to DE-A 2 842 005 and monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl)phenol and 4-(3,5-dimethylheptyl)phenol.

The aromatic polycarbonates have weight-average molecular weights M_{w} measured by GPC ((gel permeation chromatography) at room temperature in methylene chloride using a BPA polycarbonate standard)) of 15 000 to 400 000 g/mol, preferably of 18 000 to 35 000 g/mol, particularly preferably of 19 000 to 30 000 g/mol and most preferably of 20 000 bis 28 000 g/mol.

The aromatic polycarbonates may be branched in a known manner, and preferably through incorporation of 0.01 to 2.0 mol %, based on the sum of the diphenols used, of trifunctional or more than trifunctional compounds, for example those having three or more phenolic groups.

It is preferable to employ linear aromatic polycarbonates, more preferably linear aromatic polycarbonates based on bisphenol A, particularly preferably exclusively based on bisphenol A.

Aromatic dicarbonyl dihalides for production of aromatic polyestercarbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio between 1:20 and 20:1.

Production of polyestercarbonates additionally makes concomitant use of a carbonyl halide, preferably phosgene, as the bifunctional acid derivative.

Useful chain terminators for the production of the aromatic polyester carbonates include, apart from the monophenols already mentioned, the chlorocarbonic esters thereof and the acid chlorides of aromatic monocarboxylic acids, which may optionally be substituted by C1 to C22-alkyl groups or by halogen atoms, and aliphatic C2 to C22-monocarbonyl chlorides.

The production of aromatic polyester carbonates may additionally employ one or more aromatic hydrocarboxylic acids.

The aromatic polyester carbonates may be either linear or else branched in a known manner (see DE-A 2 940 024 and DE-A 3 007 934), wherein linear polyester carbonates are preferred.

Branching agents that may be used are for example tri- or polyfunctional carbonyl chlorides, such as trimesoyl trichloride, cyanuroyl trichloride, 3,3′,4,4′-benzophenonetetracarbonyl tetrachloride, 1,4,5,8-naphthalenetetracarbonyl tetrachloride or pyromellitoyl tetrachloride, in amounts of 0.01 to 2.0 mol % based on the dicarbonyl dichlorides employed or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri (4-hydroxyphenyl)benzene, 1,1,1-tri(4-hydroxyphenypethane, tri(4-hydroxyphenyl)phenyl methane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of 0.01 to 2.0 mol % based on the diphenols employed. Phenolic branching agents may be initially charged together with the diphenols; acid chloride branching agents may be introduced together with the acid dichlorides.

The proportion of carbonate structural units in the thermoplastic aromatic polyestercarbonates may be varied as desired. The proportion of carbonate groups is preferably up to 100 mol %, in particular up to 80 mol %, particularly preferably up to 50 mol %, based on the sum of ester groups and carbonate groups. The ester fraction of the aromatic polyester carbonates, and also the carbonate fraction thereof, can take the form of blocks or can have random distribution in the polycondensate.

It is preferable to employ exclusively linear aromatic polycarbonates based on bisphenol A, particularly preferably exclusively based on bisphenol A.

### Component B

Component B is a copolymer containing structural units derived from methyl methacrylate and 0.3% to 15% by weight, preferably 0.5 to 10% by weight, particularly preferably 0.8% to 9% by weight, most preferably 1% to 8% by weight of structural units derived from glycidyl methacrylate (GMA). It is also possible to employ mixtures of such copolymers.

The expression “copolymer containing structural units derived from” is to be understood as meaning that the copolymer is produced from the recited monomers by copolymerization.

Component B has a weight-average molecular weight M_{w} determined by gel permeation chromatography at room temperature in tetrahydrofuran as solvent using a polystyrene standard of 20 000 bis 200 000 g/mol, preferably of 30 000 to 150 000 g/mol, particularly preferably of 30 000 to 100 000 g/mol, most preferably of 50 000 bis 80 000 g/mol.

In component B the ratio of M_{w} in kg/mol to the weight fraction of glycidyl methacrylate-derived structural units in % by weight is in the range from 2 to 100, preferably in the range from 5 to 80, particularly preferably in the range from 5 to 50 and most preferably in the range from 8 to 30.

The copolymers of component B may contain up to 50% by weight, preferably up to 25% by weight, particularly preferably up to 10% by weight, of further structural units derived from copolymerizable vinylic, preferably acrylic (i.e. acryloyl-containing), monomers. Suitable copolymerizable acrylic monomers include for example methyl acrylate, ethyl acrylate, propyl acrylate, butyl acrylate, hexyl acrylate, 2-ethylhexyl acrylate, butyl methacrylate and other compounds structurally related to these recited acrylates.

In a most preferred embodiment component B contains no structural units derived from further copolymerizable monomers.

The copolymers of component B are thermoplastic.

Production of the copolymers of component B containing structural units derived from methyl methacrylate and glycidyl methacrylate is known to those skilled in the art and is preferably carried out by free-radically initiated polymerization of the corresponding monomers, in particular by emulsion, suspension, solution or bulk polymerization.

In the case of solution polymerization, which is preferably carried out in aprotic solvents, for example optionally halogen-substituted aliphatic or aromatic hydrocarbons as solvent, it is preferable to maintain conditions which at least largely avoid hydrolysis of the epoxide groups. Suitable and preferred conditions therefor are, for example, low contents of polar solvents such as water, alcohol, acids or bases, and the use of solvents from the group of the organic hydrocarbons inert toward epoxy groups, for example toluene, ethylbenzene, xylene, high-boiling aliphatics, chlorinated aromatic hydrocarbons such as mono-, di- tri- or tetrachlorobenzenes, chlorinated aliphatic hydrocarbons such as dichloromethane or chloroform, ketones such as methyl ethyl ketone, esters or ethers.

Addition of chain transfer agents, especially of sulfur chain transfer agents, in particular of mercaptans, makes it possible to adjust the molecular weights of component B in the free-radical polymerization such as to achieve the weight-average molecular weight M_{w} according to the invention.

### Component C

As component C the composition may contain one or more polymer additives, processing auxiliaries and/or further polymeric components distinct from A and B, preferably selected from the group consisting of flame retardants, anti-drip agents, flame retardant synergists, smoke inhibitors, lubricants and demolding agents, nucleating agents, polymeric and nonpolymeric antistats, conductivity additives, stabilizers (for example hydrolysis, heat aging and UV stabilizers and also transesterification inhibitors), flow promoters, phase compatibilizers, impact modifiers (either with or without a core-shell structure), polymeric blend partners, catalysts, fillers and reinforcers and dyes and pigments.

The choice and amount of component C is carried out such that the influences on the mechanical properties and transparency of the molded articles produced from the molding compounds are as slight as possible, i.e. the addition of component C does not run stand in the way of achieving the object of the invention.

When component C is employed it is employed in an amount of not more than 20% by weight based on the composition. This proportion is then the sum of all polymer additives, processing auxiliaries and polymeric components employed as component C.

Anti-drip agents, flame retardant synergists, smoke inhibitors, lubricants and demolding agents, nucleating agents, nonpolymeric antistats, conductivity additives and stabilizers are preferably each employed in a proportion of 0.1% to 1% by weight and preferably in total employed in a proportion of 0.1% to 3% by weight based on the composition.

When flame retardants are used it is preferable to use 1% to 15% by weight based on the composition.

When flow promoters, polymeric antistats and phase compatibilizers are employed the proportion used is in each case preferably 1% to 10% by weight and in total preferably 1% to 15% by weight based on the composition.

When impact modifiers or polymeric blend partners are employed the proportion used is in total preferably 1% to 18% by weight based on the composition.

When dyes or pigments are employed the proportion used is preferably 0.1% to 10% by weight based on the composition.

In a preferred embodiment inorganic pigments are used in a total proportion of not more than 3% by weight, particularly preferably of not more than 1.5% by weight, more preferably of not more than 0.5% by weight, in each case based on the composition. In the most preferred embodiment no inorganic pigments are employed as a constituent of component C.

If fillers and reinforcing materials are employed the proportion used is preferably 3% to 10% by weight based on the composition.

In a preferred embodiment no fillers and reinforcers are employed.

In a preferred embodiment at least one polymer additive selected from the group consisting of lubricants and mold release agents, stabilizers, flow promoters, phase compatibilizers, impact modifiers, further polymeric blend partner and dyes is employed.

In a preferred embodiment pentaerythritol tetrastearate is used as a demolding agent.

In a preferred embodiment at least one representative selected from the group consisting of sterically hindered phenols, organic phosphites and sulfur-based co-stabilizers is used as a stabilizer.

In a particularly preferred embodiment at least one representative selected from the group consisting of octadecyl-3-(3,5-di-tert-butyl-4-hydroxyphenyl)propionate and tris(2,4-di-tert-butylphenyl)phosphite is used as a stabilizer.

In a particularly preferred embodiment a metal acetylacetonate is employed as a constituent of component C. Examples of suitable metal acetylacetonates are aluminum(III) acetylacetonate, Ni(II) acetylacetonate, Fe(III) acetylacetonate, Zn acetylacetonate, Zr(IV) acetylacetonate, La(III) acetylacetonate and Sa(III) acetylacetonate. It is also possible to employ or mixtures of two or more metal acetylacetonates. It is particularly preferable to employ zirconium(IV) acetylacetonate as the metal acetylacetonate. The metal acetylacetonates are preferably employed in a total amount of 0.01 to 0.2% by weight, particularly preferably in a total amount of 0.02 to 0.15% by weight, most preferably in a total amount of 0.03% to 0.1% by weight, in each based on the composition.

Production of Molding Compounds and Molded Articles from the Compositions According to the Invention

The compositions according to the invention may be used to produce thermoplastic molding compounds.

The thermoplastic molding compounds according to the invention may be produced, for example, by mixing the respective constituents of the compositions with one another at temperatures of 200° C. to 320° C., preferably at 240° C. to 300° C., particularly preferably at 250° C. to 270° C.

The invention also provides a corresponding process for producing the molding compounds according to the invention.

The process comprises the steps of:
(i) melting the constituents of the composition by introducing thermal energy and/or mechanical shear,
(ii) mixing and dispersing the different components of the composition with or in each other,
(iii) solidifying the melt by cooling,
(iv) granulating the solidified polymer blend resulting from steps (i)-(iii).

The residence time of the components at the abovementioned temperatures is preferably in a range from 15 seconds to 30 minutes, more preferably 30 seconds to 20 minutes. When using extruders or continuous co-kneaders as the compounding unit the residence time is preferably 15 seconds to 5 minutes, particularly preferably 30 seconds to 2 minutes.

It is also possible to carry out a degassing of the present composition by application of negative pressure after step ii). The absolute pressure established is preferably not more than 400 mbar, more preferably not more than 200 mbar, particularly preferably not more than 100 mbar.

Mixing may be carried out in customary apparatuses, for example in single-screw extruders, co-rotating or counter-rotating twin-screw extruders, planetary roller extruders, internal kneaders or continuous or discontinuous co-kneaders. The compositions are melt-compounded or melt-extruded therein to form molding compounds. In the context of the present application this process is generally referred to as compounding. The term “molding compound” is thus to be understood as meaning the product obtained when the constituents of the composition are melt-compounded and melt-extruded. The present invention further provides such a molding compound.

The mixing of the individual constituents of the compositions may be carried out in a known manner, either successively or simultaneously, either at about 20° C. (room temperature) or at a higher temperature. This means that, for example, some of the constituents may be introduced via the main intake of an extruder and the remaining constituents may be introduced later in the compounding process via a side extruder.

In a preferred embodiment when performing the above-described process the epoxy groups in the gycidyl methacrylate-derived structural units in component B are partially or completely converted in a chemical reaction. The reaction can be verified by determining the epoxy content measured according to ASTM D1652-11 (2011 version) in dichloromethane as solvent.

Performing the above-described process preferably effects a chemical coupling of component A or a portion of component A to component B or a portion of component B to form a PC-PMMA copolymer. The copolymer from the reaction of the polymers A and B is generally a block copolymer or graft copolymer.

It is further preferable when the mixture containing components A, B and optionally C employed in step i) has a residual moisture content determined by Karl Fischer titration of 0.01% to 0.50% by weight, more preferably 0.07% to 0.20% by weight, in each case based on the sum of A, B and C. At excessively high moisture content there is a risk of undesirably high molecular weight degradation.

The molding compounds of the invention may be used to produce molded articles of any kind. These may be produced by injection molding, extrusion and blow molding processes for example. A further form of processing is the production of molded articles by thermoforming from previously produced sheets or films. The molding compounds according to the invention are particularly suitable for processing by extrusion, blow-molding and thermoforming methods.

It is also possible to meter the constituents of the composition directly into the conveying extruder of an injection molding machine, to thus produce the molding compound in the conveying extruder and to effect direct processing into molded articles by appropriate discharging of the molding compound into an injection mold (compounding or reactive compounding injection molding).

The present invention further provides such a process comprising the steps of:
(i) metering the constituents of the composition according to the invention into the conveying extruder of an injection molding machine,
(ii) melting the constituents of the composition according to the invention by introducing thermal energy and/or mechanical shear,
(iii) conveying the melt to the discharging point of the extruder,
(iv) discharging the melt from the conveying extruder into an injection mold,
(v) cooling and solidifying the melt in the injection molded to form a molded article,
(vi) removing the molded article from the injection mold.

In a preferred embodiment of this process the residence time of the melt in the conveying extruder is at least two minutes, more preferably at least five minutes, particularly preferably at least ten minutes.

In a preferred embodiment of this process the residence time of the melt in the conveying extruder is 2 to 30 minutes, more preferably 5 to 20 minutes, particularly preferably 7 to 15 minutes.

In a preferred embodiment, process steps (iii) and (iv) are carried out under shear. This may be achieved for example via a high screw speed during melt conveying in step (iii) and/or via a suitable screw configuration of the conveyor screw, for example through the use of kneading elements, and through a suitably narrow geometry of the melt outlet nozzle in step (iv).

The present invention thus further relates to the use of a composition according to the invention or of a molding compound according to the invention for producing molded articles and also to a molded article obtainable from a composition according to the invention or from a molding compound according to the invention or containing such a molding compound.

Examples of such molded articles are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automobile sector. The compositions and molding compounds according to the invention are also suitable for producing the following molded articles or moldings: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

On account of their particular technical properties the compositions and molding compound according to the invention are particularly suitable for producing molded articles transilluminable by light in the visible wavelength range, for example from an LED light source, for illumination applications in the automotive sector, in the construction sector and in the electronics sector. They are especially suitable for producing transilluminable moldings for use in automotive interiors such as for example instrument panel carriers or decorative trim pieces or in automotive body applications intended to serve for example for ambient lighting or appropriately switchable functional display functions (for example day/night differentiation).

Further embodiments of the present invention are as follows.
1. Composition for producing a thermoplastic molding compound containing
   A) at least one aromatic polycarbonate and/or aromatic polyester carbonate containing at least 500 ppmw of phenolic OH groups, wherein the weight-average molecular weight M_{w} of component A determined by gel permeation chromatography at room temperature in dichloromethane as solvent using a BPA polycarbonate standard is in the range from 15 000 to 40 000 g/mol,
   B) at least one copolymer containing structural units derived from methyl methacrylate and 0.3% to 15% by weight, based on component B, of structural units derived from glycidyl methacrylate (GMA), wherein component B has a weight-average molecular weight M_{w} determined by gel permeation chromatography at room temperature in tetrahydrofuran as solvent using a polystyrene standard of 20 000 to 200 000 g/mol,
      wherein in component B the ratio of M_{w} in kg/mol to the weight fraction of glycidyl methacrylate-derived structural units in % by weight is in the range from 2 to 100,
wherein the weight ratio of components A and B is in the range from 30:70 to 90:10.
2. Composition according to embodiment 1, wherein in component B the ratio of M_{w} in kg/mol to the weight fraction of glycidyl methacrylate-derived structural units in % by weight is in the range from 5 to 80.
3. Composition according to embodiment 1, wherein in component B the ratio of M_{w} in kg/mol to the weight fraction of glycidyl methacrylate-derived structural units in % by weight is in the range from 5 to 50.
3. Composition according to embodiment 1, wherein in component B the ratio of M_{w} in kg/mol to the weight fraction of glycidyl methacrylate-derived structural units in % by weight is in the range from 8 to 30.
4. Composition according to any of the preceding embodiments, wherein the product of the phenolic OH amount in ppmw introduced into the composition via component A and the amount of glycidyl methacrylate-derived structural units in % by weight introduced into the composition via component B is greater than 300.
5. Composition according to any of the preceding embodiments, wherein component A has a weight-average molecular weight M_{w} measured by gel permeation chromatography at room temperature in methylene chloride as solvent using a BPA polycarbonate standard of 18 000 to 35 000 g/mol.
6. Composition according to any of the preceding embodiments, wherein component A has a weight-average molecular weight M_{w} measured by gel permeation chromatography at room temperature in methylene chloride as solvent using a BPA polycarbonate standard of 19 000 to 30 000 g/mol.
7. Composition according to any of the preceding embodiments, wherein component A has a weight-average molecular weight M_{w} measured by gel permeation chromatography at room temperature in methylene chloride as solvent using a BPA polycarbonate standard of 20 000 to 28 000 g/mol.
8. Composition according to one of the preceding embodiments, wherein component B contains 0.5% to 10% by weight of structural units derived from glycidyl methacrylate.
9. Composition according to one of the preceding embodiments, wherein component B contains 0.8% to 9% by weight of structural units derived from glycidyl methacrylate.
10. Composition according to one of the preceding embodiments, wherein component B contains 1% to 8% by weight of structural units derived from glycidyl methacrylate.
11. Composition according to any of the preceding embodiments, wherein component B has a weight-average molecular weight M_{w} measured by gel permeation chromatography at room temperature in tetrahydrofuran as solvent using a polystyrene standard of 30 000 to 150 000 g/mol.
12. Composition according to any of the preceding embodiments, wherein component B has a weight-average molecular weight M_{w} measured by gel permeation chromatography at room temperature in tetrahydrofuran as solvent using a polystyrene standard of 30 000 to 100 000 g/mol.
13. Composition according to any of the preceding embodiments, wherein component B has a weight-average molecular weight M_{w} measured by gel permeation chromatography at room temperature in tetrahydrofuran as solvent using a polystyrene standard of 50 000 to 80 000 g/mol.
14. Composition according to any of the preceding embodiments, wherein component A has a proportion of phenolic OH groups of 500 ppmw to 3000 ppmw.
15. Composition according to any of the preceding embodiments, wherein component A has a proportion of phenolic OH groups of at least 1000 ppmw.
16. Composition according to any of the preceding embodiments, wherein component A has a proportion of phenolic OH groups of at least 1500 ppmw.
17. Composition according to any of the preceding embodiments, wherein component A has a proportion of phenolic OH groups of 1500 ppmw to 3000 ppmw.
18. Composition according to any of the preceding embodiments, wherein component A has a proportion of phenolic OH groups of at least 1800 ppmw.
19. Composition according to any of the preceding embodiments, wherein component A has a proportion of phenolic OH groups of 1800 ppmw to 2800 ppmw.
20. Composition according to one of the preceding embodiments, where the component A employed is an aromatic polycarbonate produced in the melt polymerization process.
21. Composition according to embodiment 20, wherein a molar ratio of diphenyl carbonate to diphenols in the range from 1.00 to 1.07 is established during production of component A.
22. Composition according to embodiment 20, wherein a molar ratio of diphenyl carbonate to diphenols in the range from 1.02 to 1.04 is established during production of component A.
23. Composition according to any of the preceding embodiments, wherein the component A employed is exclusively linear aromatic polycarbonate based exclusively on bisphenol-A.
24. Composition according to any of the preceding embodiments consisting of
30% to 90% by weight of component A,
10% to 70% by weight of components B,
0% to 20% by weight of polymer additives, processing aids and/or polymers distinct from components A and B as component C,
wherein the % by weight amounts of components A to C are chosen such that they sum to 100% by weight.
25. Composition according to any of the preceding embodiments consisting of
45% to 85% by weight of component A,
14% to 54% by weight of components B,
0.01% to 5% by weight of polymer additives, processing aids and/or polymers distinct from components A and B as component C,
wherein the % by weight amounts of components A to C are chosen such that they sum to 100% by weight.
26. Composition according to any of the preceding embodiments consisting of
48% to 82% by weight of component A,
17% to 41% by weight of components B,
0.02% to 1% by weight of polymer additives, processing aids and/or polymers distinct from components A and B as component C,
wherein the % by weight amounts of components A to C are chosen such that they sum to 100% by weight.
27. Composition according to any of embodiments 24 to 26, wherein component C contains a metal acetylacetonate.
28. Composition according to embodiment 27, wherein the metal acetylacetonate is at least one compound selected from the group consisting of aluminum(III) acetylacetonate, Ni(II) acetylacetonate, Fe(III) acetylacetonate, Zn acetylacetonate, Zr(IV) acetylacetonate, La(III) acetylacetonate and Sa(III) acetylacetonate.
29. A composition according to any one of embodiments 27 and 28, wherein the metal acetylacetonate is Zr(IV) acetylacetonate.
30. A composition according to any one of embodiments 27 to 29, wherein component C contains the metal acetylacetonate in an amount of 0.01% to 0.2% by weight based on the composition.
31. Composition according to any of embodiments 27 to 30, wherein the metal acetylacetonate is Zr(IV) acetylacetonate and is employed in an amount of 0.02% to 0.15% by weight based on the composition.
32. Composition according to any of embodiments 27 to 31, wherein the metal acetylacetonate is Zr(IV) acetylacetonate and is employed in an amount of 0.03% to 0.1% by weight based on the composition.
33. Composition according to of the preceding embodiments, wherein in component B the ratio of M_{w} in kg/mol to the weight fraction of glycidyl methacrylate-derived structural units in % by weight is in the range from >50 to 100.
34. Process for producing a thermoplastic molding compound consisting of the steps of
   (i) melting the constituents of a composition according to any of the preceding embodiments by introducing thermal energy and/or mechanical shear,
   (ii) mixing and dispersing the different components of the composition with or in each other,
   (iii) solidifying the melt by cooling,
   (iv) granulating the solidified polymer blend resulting from steps (i)-(iii),
wherein step (ii) is carried out in a compounding apparatus selected from the group consisting of single-screw extruders, co-rotating or counter-rotating twin-screw extruders, planetary roller extruders, internal kneaders or co-kneaders.
35. Process according to embodiment 34, wherein in the process the epoxy groups from component B are partially or completely converted in a chemical reaction.
36. Process according to embodiment 34 or 35, wherein the process effects a chemical coupling of component A or a portion of component A to component B or a portion of component B.
37. Thermoplastic molding compound obtained by a process according to any of embodiments 34 to 36.
38. Molding compound according to embodiment 37, wherein the molding compound has a total luminous transmittance measured according to ISO 13468-1 (2019 version) on a molded article having a thickness of 1 mm of at least 35%.
39. Molding compound according to embodiment 37, wherein the molding compound has a total luminous transmittance measured according to ISO 13468-1 (2019 version) on a molded article having a thickness of 1 mm of at least 50%.
40. Use of a thermoplastic molding compound according to any of embodiments 37 to 39 for producing molded articles.
41. Molded article containing a thermoplastic molding compound according to any of the embodiments 37 to 39.
42. Molded article consisting of a thermoplastic molding compound according to any of embodiments 37 to 39, wherein the molded article has a flexural strength measured according to ISO 178 (2019 version) of at least 100 MPa.
43. Molded article consisting of a thermoplastic molding compound according to any of embodiments 37 to 39, wherein the molded article has a scratch resistance measured as pencil hardness based on the Wolff-Wilborn method of at least 2H.
44. Process for producing a molded article, comprising the steps of
(i) metering the constituents of a composition according to any of embodiments 1 to 33 into the conveying extruder of an injection molding machine,
(ii) melting the constituents of the composition by introducing thermal energy and/or mechanical shear,
(iii) conveying the melt to the discharging point of the extruder,
(iv) discharging the melt from the conveying extruder into an injection mold,
(v) cooling and solidifying the melt in the injection molded to form a molded article,
(vi) removing the molded article from the injection mold.
45. Process according to embodiment 44, wherein the residence time of the melt in the conveying extruder is at least 5 minutes.
46. Process according to embodiment 44, wherein the residence time of the melt in the conveying extruder is at least 7 to 15 minutes.
47. Process according to any of embodiments 44 to 46, wherein process steps (iii) and (iv) are carried out under shear.
48. Molded article according to any of embodiments 41 to 43 or obtainable by a process according to any of embodiment 44 to 47, wherein said article is a molded article transilluminable by light in the visible wavelength range, for example from an LED light source, for illumination applications in the automotive sector, in the construction sector and in the electronics sector.
49. Molded article according to embodiment 48, wherein said article is an instrument panel carrier or a decorative trim piece or a molded article for an automotive body application and wherein the molded article is intended to serve for example for ambient lighting or appropriately switchable functional display functions (for example day/night differentiation).

### EXAMPLES

### Compositions

### Component A1

Bisphenol A-based polycarbonate produced in the interfacial process having a weight-average molecular weight M_{w} of 25 000 g/mol measured at room temperature in methylene chloride as solvent with an FTIR detector at a wavenumber of 1775 cm⁻¹ against a BPA polycarbonate calibration standard. Component A1 contains <100 ppmw of phenolic OH groups measured using ¹H NMR spectroscopy.

### Component A2

Bisphenol A-based polycarbonate produced in the melt polymerization process having a weight-average molecular weight M_{w} of 24 000 g/mol (Mₙ of 11 000 g/mol) measured at room temperature in methylene chloride as solvent with an FTIR detector at a wavenumber of 1775 cm⁻¹ and against a BPA polycarbonate calibration standard. Component A2 contains 2200 ppmw of phenolic OH groups measured using ¹H NMR spectroscopy. A molar ratio of diphenyl carbonate to bisphenol A of 1.02 was employed during production.

### Component A3

Bisphenol A-based polycarbonate produced in the interfacial process having a weight-average molecular weight M_{w} of 20 000 g/mol measured at room temperature in methylene chloride as solvent with an FTIR detector at a wavenumber of 1775 cm⁻¹ and against a BPA polycarbonate calibration standard. Component A3 contains <100 ppmw of phenolic OH groups measured using ¹H NMR spectroscopy.

### Component A4

Bisphenol A-based polycarbonate produced in the melt polymerization process having a weight-average molecular weight M_{w} of 20 000 g/mol (Mₙ of 9200 g/mol) measured at room temperature in methylene chloride as solvent with an FTIR detector at a wavenumber of 1775 cm⁻¹ and against a BPA polycarbonate calibration standard. Component A4 contains 2700 ppmw of phenolic OH groups measured using ¹H NMR spectroscopy. A molar ratio of diphenyl carbonate to bisphenol A of 1.02 was employed during production.

### Component B1

Polymethyl methacrylate having a weight average molecular weight M_{w} of 58 000 g/mol measured by gel permeation chromatography at room temperature in tetrahydrofuran as solvent with a refractive index detector and against a polystyrene calibration standard.

### Component B2

Random polymethyl methacrylate-glycidyl methacrylate copolymer having a content of glycidyl methacrylate-derived structural units of 1% by weight and having a weight-average molecular weight M_{w} of 34 000 g/mol measured by gel permeation chromatography at room temperature in tetrahydrofuran as solvent with a refractive index detector and against a polystyrene calibration standard.

### Component B3

Random polymethyl methacrylate-glycidyl methacrylate copolymer having a content of glycidyl methacrylate-derived structural units of 1% by weight and having a weight-average molecular weight M_{w} of 60 000 g/mol measured by gel permeation chromatography at room temperature in tetrahydrofuran as solvent with a refractive index detector and against a polystyrene calibration standard.

### Component B4

Random polymethyl methacrylate-glycidyl methacrylate copolymer having a content of glycidyl methacrylate-derived structural units of 8% by weight and having a weight-average molecular weight M_{w} of 68 000 g/mol measured by gel permeation chromatography at room temperature in tetrahydrofuran as solvent with a refractive index detector and against a polystyrene calibration standard.

### Component C1

Catana™ CAA 2950: Zirconium(IV) acetylacetonate catalyst (Sachem Inc., Austin, Texas, USA)

### Production of Thermoplastic Molding Compounds

The raw materials used to produce the thermoplastic molding compounds were dried under vacuum at 60° C. for at least 7 hours before compounding. Both polymeric components A and B were employed in the compounding in the form of powders which were produced from granulates by cryomilling.

The thermoplastic molding compounds composed of the compositions shown in table 1 were produced in a DSMXplore® MC15 discontinuous microcompounder (Xplore Instruments BV, Sittard, Netherlands) at a melt temperature of 260° C. and a speed of 100 rpm with a residence time of 15 min from previously produced powder mixtures of the components A, B and optionally C. The batch size was 15 g, from which about 7 g of material suitable for further characterization of the compounds was obtained.

The thermoplastic molding compounds composed of the compositions shown in table 2 were compounded in a Process 11 continuous twin-screw extruder (Thermofischer Scientific, Karlsruhe, Germany) having a dispersing screw configuration comprising three mixing zones at a melt temperature of 260° C., a throughput of about 300 g/h, a speed of 200 min⁻¹ and a residence time of about 90 seconds and after discharge through a die plate the extrudate was cooled and thus solidified and subsequently granulated. For these compoundings too, powder mixtures of the components A to C were initially produced and uniformly metered into the feed zone of the twin-screw extruder via a volumetric metering device. To achieve the most homogeneous possible distribution of the very small amounts of component C in these powder mixtures, component C was as uniformly as possible applied to the powder mixture of the components A and B as a 2% by weight solution in ethanol and the resulting mixture was subsequently heat treated at 60° C. in a forced circulation oven and then dried overnight by application of a vacuum 60° C. (i.e. the ethanol was removed again).

### Production of the Test Specimens

The thermoplastic molding compounds produced from the compositions according to table 1 were used to produce round plates having a diameter of 18 mm and a thickness of 1 mm for the transmittance measurements and non-standard mini flat bar test specimens measuring 30 mm×6 mm×1 mm for the 3-point flexural tests at a temperature of 260° C., a pressure of 60 bar and a total pressing time of 4 min in a laboratory thermal press from P/O/Weber (Remshalden, Germany).

The thermoplastic molding compounds produced from the compositions according to table 2 were used to produce rectangular plates measuring 80 mm×80 mm×1 mm and test bars having dimensions of 80 mm×10 mm×4 mm at a melt temperature of 270° C., a mold temperature of 60° C. and an injection pressure of 2000 bar in an Arburg 470 H 1000-170 injection molding machine from Arburg GmbH+Co KG (LoBburg, Germany). Under the same conditions non-standard dumbbell test specimens were produced for the tensile tests measuring I₃=120 mm (total length), I₂=83 mm (distance between wide parallel parts), I₁=70 mm (length of narrow parallel part), h=3 mm (thickness), b₁=8 mm (width of narrow part) and b₂=16 mm (width at end), wherein the descriptions of the dimensions of the test specimens are identical to those in DIN EN ISO 527-2 (1996 version).

### Performance Tests

The tensile strain properties (tensile strength and elastic modulus) were determined at room temperature in a tensile test based on ISO 527-1 (2019 version) on non-standard dumbbell test specimens. Based on ISO 527-1 is to be understood as meaning that non-standard dumbbell test specimens were used.

Determination of flexural strength, flexural modulus, breaking elongation or—in the case of the tests on non-standard test specimens—deflection length at fracture failure was carried out at room temperature in 3-point flexural tests on test bars measuring 30 mm×6 mm×1 mm (table 1) or 80 mm×10 mm×4 mm (table 2). Testing on the test bars measuring 80 mm×10 mm×4 mm (table 2) was carried out according to ISO 178 (2019 version). The 3-point flexural tests on the non-standard test bars measuring 30 mm×6 mm×1 mm (table 1) were performed at a test speed of 5 mm/min using a GABO EPLEXOR® 500 N tester from Netzsch Geratebau GmbH (Selb, Germany).

The so-called pencil hardness was determined as a measure of scratch resistance. Measurement was carried out at room temperature using a TriForcePencil 293 scratch hardness tester from Erichsen GmbH & Co. KG (Hemer, Germany) according the manufacturer test procedure and based on the Wolff-Wilborn method on test plates measuring 80 mm×80 mm×1 mm. To this end, the pencils were clamped into the measuring instrument at an angle to the test surface of 45° and drawn over the specimen surface at a test force of 5 N. The test was commenced with the hardest pencil and the hardness was then successively reduced. The pencil hardness of the pencil whose point is the first one to no longer leave behind a noticeable scratch in this procedure is considered the parameter that characterizes the scratch resistance of the plastic surface.

Suncream resistance was determined using the suncream test mixture MB-PM001 obtained from Thierry Präzisionslackiertechnik GmbH (Stuttgart, Germany) on rectangular plates measuring 80 mm×80 mm×1 mm. The test specimens were initially cleaned with DM water and blow-dried before a suncream droplet of about 7-10 mm in diameter was applied to the test specimen. The samples treated with the suncream test mixture in this way were then stored at 50° C. for 6 h or 24 h. After cooling the test specimens to room temperature the suncream was carefully removed from the test specimen with a cloth and the test specimens then finally stored at room temperature for a further 7 days before being analyzed for fractures/haze according to ISO 14782 (1999 version). One criterion for suncream resistance is whether exposure to suncream results in cracking on the test specimen (worst behavior). For the molding compounds which do not undergo such cracking on the test specimen, the change in haze (i.e. the difference in haze values before and after suncream exposure) serves as a measure for suncream resistance, wherein a lower change in haze corresponds to an improved suncream resistance.

The transparencies of the molding compounds were assessed by determining the total luminous transmittance (hereinbelow referred to synonymously as “transmittance”). on round plates having a diameter of 18 mm and a thickness of 1 mm (table 1) or on rectangular plates measuring 80 mm×80 mm×1 mm (table 2) at room temperature according to ISO 13468-1 (2019 version).

TABLE 1
Compositions and properties of the molding compounds produced therefrom (molding
compounds produced in microcompounder, test specimens produced by hot pressing)

| Composition | R1 | R2 | R3 | R4 | R5 | R6 | V7 | V8 | V9 | 10 |
|---|---|---|---|---|---|---|---|---|---|---|
| A1 | 100 | | | | | | 80 | | | |
| A2 | | 100 | | | | | | 80 | 50 | 80 |
| B1 | | | 100 | | | | 20 | 20 | 50 | |
| B2 | | | | 100 | | | | | | |
| B3 | | | | | 100 | | | | | 20 |
| B4 | | | | | | 100 | | | | |
| C1 | | | | | | | | | | |
| Feature of Component B | | | | | | | | | | |
| M_{w} [kg/mol] | — | — | 58 | 34 | 60 | 68 | 58 | 58 | 58 | 60 |
| GMA structural units | | | 0 | 1 | 1 | 8 | 0 | 0 | 0 | 1 |
| [% by wt.] | | | | | | | | | | |
| M_{w} [kg/mol]/GMA | — | — | ∞ | 34 | 60 | 8.5 | ∞ | ∞ | 8 | 60 |
| [% by wt.] | | | | | | | | | | |
| Properties | | | | | | | | | | |
| Flexural strength | 84 | 90 | 86 | n.m. | 34 | 50 | 96 | 100 | 88 | 104 |
| [MPa] | | | | | | | | | | |
| deflection length at | >5.5 | >5.5 | 0.7 | n.m. | <0.3 | <0.3 | >5.5 | >5.5 | 1.3 | >5.5 |
| fracture [mm] | | | | | | | | | | |
| Transmittance [%] | | | | | | | 19 | 27 | 21 | 36 |

| Composition | 11 | 12 | 13 | 14 | 15 | 16 | V17 | V18 | V19 |
|---|---|---|---|---|---|---|---|---|---|
| A1 | | | | | | | 80 | 80 | 80 |
| A2 | 80 | 80 | 80 | 80 | 50 | 50 | | | |
| B1 | | | | | | | | | |
| B2 | | 20 | | | | | 20 | | |
| B3 | 20 | | | | | | | 20 | |
| B4 | | | 20 | 20 | 50 | 50 | | | 20 |
| C1 | 0.05 | | | 0.05 | | 0.05 | | | |
| Feature of Component B | | | | | | | | | |
| M_{w} [kg/mol] | 60 | 34 | 68 | 68 | 68 | 68 | 34 | 60 | 68 |
| GMA structural units | 1 | 1 | 8 | 8 | 8 | 8 | 1 | 1 | 8 |
| [% by wt.] | | | | | | | | | |
| M_{w} [kg/mol]/GMA | 60 | 34 | 8.5 | 8.5 | 8.5 | 8.5 | 34 | 60 | 8.5 |
| [% by wt.] | | | | | | | | | |
| Properties | | | | | | | | | |
| Flexural strength | 107 | 106 | 111 | 128 | 110 | 122 | n.d. | n.d. | n.d. |
| [MPa] | | | | | | | | | |
| deflection length at | >5.5 | >5.5 | >5.5 | >5.5 | >5.5 | >5.5 | n.d. | n.d. | n.d. |
| fracture [mm] | | | | | | | | | |
| Transmittance [%] | 70 | 64 | 60 | 52 | 56 | 39 | 17 | 17 | 18 |

n.m. = not measurable, since no test specimens were producible in the thermopress process due to excessive material brittleness and/or said specimens already fractured upon attempted demolding from the press mold due to high material brittleness
n.d. = not determined
R = reference test,
V = comparison test

As a consequence of the measuring apparatus, deflection lengths were measurable only up to a maximum of 5.5 mm. If no fracture was observed at this maximum measurable deflection length, the deflection length at break is thus reported as “>5.5 mm”.

TABLE 2
Compositions and properties of the molding compounds produced
therefrom (molding compounds produced in twin-screw extruder,
test specimens produced by injection molding)

| Composition | V20 | 21 | 22 | 23 | R24 | R25 |
|---|---|---|---|---|---|---|
| A1 | | | | | 100 | |
| A3 | 80 | | | | | |
| A4 | | 80 | 80 | 80 | | |
| B1 | 20 | | | | | 100 |
| B2 | | 20 | | | | |
| B4 | | | 20 | 20 | | |
| C1 | | | | 0.05 | | |
| Feature of Component B | | | | | | |
| M_{w} [kg/mol] | 58 | 34 | 68 | 68 | — | 58 |
| GMA structural units | 0 | 1 | 8 | 8 | — | 0 |
| [% by wt.] | | | | | | |
| M_{w} [kg/mol]/GMA | ∞ | 34 | 8.5 | 8.5 | — | ∞ |
| [% by wt.] | | | | | | |
| Properties | | | | | | |
| Flexural modulus [MPa] | 2447 | 2567 | 2519 | 2559 | | |
| Flexural strength [MPa] | 98 | 104 | 101 | 101 | | |
| Tensile modulus [MPa] | 2586 | 2768 | 2717 | 2797 | | |
| Tensile strength [MPa] | 61 | 66 | 66 | 67 | | |
| Transmittance [%] | 26 | 65 | 59 | 65 | | |
| Pencil hardness | 2H | 2H | 3H | 3H | F | 4H |
| Suncream test | yes | no | no | no | no | |
| (cracking on specimen) | | | | | | |
| Suncream test | n.m. | 20 | n.d. | n.d. | 33 | |
| (turbidity change after | | | | | | |
| 50° C./6 h) [%] | | | | | | |
| Suncream test (turbidity | n.m. | 34 | n.d. | 29 | 47 | |
| change after 50° C./24 h) | | | | | | |
| [%] | | | | | | |

n.m. = not measurable since specimen fractured as a result of sunscreen exposure.
n.d. = not determined

The data in table 1 show that the thermoplastic molding compounds produced from the inventive compositions 10 to 16 exhibit a surprising, synergistic increase in flexural strength relative to the pure components A (R2) and B (R4 to R6), relative to non-reactively modified PC/PMMA (R1 and R3) and also relative to blends produced from non-reactively modified PC and PMMA (V7) according to the prior art and relative to blends produced from OH-functionalized PC and non-reactively functionalized PMMA (V8 and V9).

The data likewise show that the thermoplastic molding compounds produced from the inventive compositions exhibit a higher flexural breaking elongation relative to non-reactively modified PMMA (R3) and PMMA polymers of component B (R4-R6).

Furthermore, the data in table 1 show that the thermoplastic molding compounds produced from the inventive compositions also have a higher transparency (transmittance) than analogous noninventive molding compounds produced from compositions containing non-reactively functionalized PC and/or PMMA (compare inventive examples 10, 12, 13 and 15 with V7 to V9 and V17 to V19).

The data in table 1 further show that such molding compounds produced from compositions containing a component B having a low M_{w} [kg/mol]/GMA content [% by wt.] ratio in the absence of a catalyst have a higher transparency and flexural strength than analogous molding compounds produced from compositions containing a component B having a relatively high M_{w} [kg/mol]/GMA content [% by wt.] ratio of for example 60 (compare example 10 with preferred examples 12 and 13).

On the other hand, the data in table 1 also show that this technical disadvantage of the inventive molding compounds produced from compositions containing the component B having a relatively high M_{w} [kg/mol]/GMA content [% by wt.] ratio of for example 60 can be overcome through the use of zirconium(IV) acetylacetonate as component C (compare examples 10 and 11), thus resulting in preferred molding compounds having particularly high transmittance.

The data in table 1 further show that, when using a component B having a very high GMA content of for example 8% by weight based on component B, the addition of zirconium acetylacetonate as component C results in a further increase in flexural strength coupled with only a slight reduction in transmittance (compare examples 13 and 15 with examples 14 and 16). Depending on the precise profile of properties that is sought, the use of zirconium acetylacetonate in such molding compounds produced from compositions containing a component B having a very high GMA content may thus be either technically preferable or less suitable for development of a product.

The data in table 2 show that similar effects as previously derived from the data of table 1 can also be realized in molding compounds and test specimens produced therefrom when the molding compounds are produced in a counter-rotating twin-screw extruder and the test specimens are produced in an injection molding process, as typically employed in the industrial manufacture of such molding compounds/moldings. This demonstrates the good production and processing stability of the inventive molding compounds.

The data in table 2 further show that, relative to analogous molding compounds according to the prior art produced from compositions containing non-reactive PC and PMMA, the inventive molding compounds also show a surprising improvement in tensile strength in the tensile test as well as a surprising improvement in modulus both in the tensile test and in the flexural test. They also show a scratch resistance (pencil hardness) which is improved relative to polycarbonate and in some cases surprisingly also relative to analogous PC+PMMA molding compounds according to the prior art that have been produced from non-reactive PC and PMMA and is virtually on the level of pure PMMA even when the PMMA component B is employed in the PC+PMMA compositions in an amount of only 20% by weight and is thus not present as a matrix component of the polymer blend (compare example 22 with comparative example V20 or with reference examples R24 and R25).

The data in table 2 also show that the inventive molding compounds have an improved suncream resistance relative to pure polycarbonate (reference example R24) and also relative to analogous PC+PMMA molding compounds according to the prior art that have been produced from non-reactive PC and PMMA (comparative example 20).

1. A composition for producing a thermoplastic molding compound containing
A) at least one aromatic polycarbonate and/or aromatic polyester carbonate containing at least 500 ppmw of phenolic OH groups, wherein the weight-average molecular weight Mw of component A determined by gel permeation chromatography at room temperature in dichloromethane as solvent using a BPA polycarbonate standard is in the range from 15 000 to 40 000 g/mol,
B) at least one copolymer containing structural units derived from methyl methacrylate and 0.3% to 15% by weight, based on component B, of structural units derived from glycidyl methacrylate, wherein component B has a weight-average molecular weight M_{w} determined by gel permeation chromatography at room temperature in tetrahydrofuran as solvent using a polystyrene standard of 20 000 to 200 000 g/mol,
wherein in component B the ratio of M_{w} in kg/mol to the weight fraction of glycidyl methacrylate-derived structural units in % by weight is in the range from 2 to 100,
wherein the weight ratio of component A and component B is in the range from 30:70 to 90:10.

2. The composition as claimed in claim 1, wherein in component B the ratio of M_{w} in kg/mol to the weight fraction of glycidyl methacrylate-derived structural units in % by weight is in the range from 5 to 50.

3. The composition as claimed in claim 1 consisting of
30% to 90% by weight of component A,
10% to 70% by weight of component B and
0% to 20% by weight of polymer additives, processing aids and/or polymers distinct from components A and B as component C,
wherein the % by weight amounts of components A to C are chosen such that they sum to 100% by weight.

4. The composition as claimed in claim 3, wherein component C contains a metal acetyl acetonate.

5. The composition as claimed in claim 4, wherein the metal acetylacetonate is Zr(IV) acetylacetonate and is present in an amount of from 0.01% to 0.2% by weight based on the composition.

6. The composition as claimed in claim 4, wherein in component B the ratio of M_{w} in kg/mol to the weight fraction of glycidyl methacrylate-derived structural units in % by weight is in the range from >50 to 100.

7. The composition as claimed in claim 1, wherein component B has a weight-average molecular weight M_{w} measured by gel permeation chromatography at room temperature in tetrahydrofuran as solvent using a polystyrene standard of 50 000 to 80 000 g/mol.

8. The composition as claimed in claim 1, wherein component A has a proportion of phenolic OH groups of 1500 to 3000 ppmw.

9. A process for producing a thermoplastic molding compound comprising the steps of
(i) melting the constituents of a composition according to claim 1 by introducing thermal energy and/or mechanical shear,
(ii) mixing and dispersing the different components of the composition with or in each other,
(iii) solidifying the melt by cooling,
(iv) granulating the solidified polymer blend resulting from steps (i)-(iii),
wherein step (ii) is carried out in a compounding apparatus selected from the group consisting of single-screw extruders, co-rotating or counter-rotating twin-screw extruders, planetary roller extruders, internal kneaders or co-kneaders.

10. The process as claimed in claim 9, wherein in the process the epoxy groups from component B are partially or completely converted in a chemical reaction.

11. The process as claimed in claim 9, wherein the process effects a chemical coupling of component A or a portion of component A to component B or a portion of component B.

12. A thermoplastic molding compound obtained in a process as claimed in claim 9.

13. (canceled)

14. A molded article containing the thermoplastic molding compound as claimed in claim 12.

15. Process for producing a molded article, comprising the steps of
(i) metering the constituents of a composition as claimed in claim 1 into the conveying extruder of an injection molding machine,
(ii) melting the constituents of the composition by introducing thermal energy and/or mechanical shear,
(iii) conveying the melt to the discharging point of the extruder,
(iv) discharging the melt from the conveying extruder into an injection mold,
(v) cooling and solidifying the melt in the injection molded to form a molded article,
(vi) removing the molded article from the injection mold.
